(19) United States
(12) Patent Application Publication
(10) Pub. No.: US 2018/0018706 A1
(43) Pub. Date: Jan. 18, 2018

(54) DATA MANAGEMENT PLATFORM AND METHOD OF BRIDGING OFFLINE COLLECTED DATA WITH AUTOMATED ONLINE RETARGETED ADVERTISING

(71) Applicant: Catalyst Trade c/o Jeffrey Tognetti, Key Biscayne, FL (US)

(72) Inventor: Jeffrey TOGNETTI, Key Biscayne, FL (US)

(73) Assignee: Catalyst Trade c/o Jeffrey Tognetti, Key Biscayne, FL (US)

(21) Appl. No.: 15/212,783

(22) Filed: Jul. 18, 2016

(51) Int. Cl. G06Q 30/02; H04L 29/08

(52) U.S. Cl. CPC G06Q 30/0269; H04L 67/306; G06Q 30/0275; G06Q 30/0277; H04L 67/02

(57) ABSTRACT

A method and system that can be used to bridge offline and online retargeting of advertisements. A business may collect customer information, for example customer browsing activity on a business website or customer communications with the business. This data may then be on-boarded to a data management platform. Keywords may be harvested from the customer information, and the customer's subsequent internet browsing behavior may be tracked, for example by submitting a customer ID to an ad exchange in a bid request, and receiving, in the reply to the bid request, browsing data for the customer. When the customer visits sites relevant to the keywords, such as sites with the keywords in the URL, the customer may be determined to be in the market for a particular product and the customer may be the subject of a retargeted advertisement, such as a phone solicitation.

### BACKGROUND

Online advertising dates back to the early days of the Internet, and has benefited from significant innovation from advertisers in that time. One focus of innovation has been to make ads subtler and less intrusive, so that fewer users are turned off by the presence of the ad on a page or are unable to access content because of advertising. Another focus has been to make ads “smarter” and more targeted in order to improve their effect, and in order to identify the users that ads are actually reaching.

One of the most significant recent innovations in digital advertising has been the growth of user tracking. The actions of a user who visits one site and then another may be tracked by any of a variety of advertising tracker services, which may then compile the actions of the user into a database, along with other known information about the user such as the user's browsing history and search history. This information may then be used as the basis for sorting the user into one or more behavioral categories. When the user later navigates to another page served by the advertising tracker service, and the user is identified in the database, targeted advertising or personalized content may be presented to the user based on the database records of the user's past activities or the user's behavioral category or categories, or other pertinent information. This also allows media purchasers to have a sense of what users any ads that they pay for are reaching, allowing media purchasers to evaluate the cost-effectiveness of any advertising campaigns that they pay for.

The ease with which user tracking can be integrated with digital advertising, and the major benefits which it provides to media purchasers over “dumb ads,” has caused it to become highly popular. Media purchasers can ensure that fewer of their ads are wastefully mistargeted, and can even choose to pay more or less for ads based on which ads lead to more or fewer online purchases.

However, not all advertising leads to online purchases, and a number of products are still purchased offline, such as in person or over the phone. Some solutions for tracking offline purchases have been devised; for example, a retailer may offer a store rewards card to customers that provides them with a small discount or with a points reward whenever they scan their card with a purchase, which may allow the retailer to track the purchases of that customer by tracking the store rewards card ID. However, other than motivating users to self-identify with such a card, there is little ability to track users or to integrate offline tracking with online tracking. This makes it more difficult for media purchasers to manage and measure the return on their investment for both online and offline advertisements that may lead to an offline transaction, such as advertisements in print media or advertisements pushed to a user's mobile device through an app, each of which may request that the user call a designated phone number.

This may also have downsides for the sellers of advertising space, which may include, for example, the developers of mobile applications that show ads, or publishers of print media. Ad purchasers often make decisions about where to purchase advertising space based on the historical effectiveness of advertising in a particular medium, and may even structure payment for advertising space to be based on the demonstrated effectiveness of the advertising. If a particular promotion results in a phone purchase or an in-person purchase being made of an item, and the purchase cannot be traced back to the promotion, the ad purchaser may not appreciate the actual effectiveness of the ad. This may cause sellers of advertising space to be unable to sell valuable advertising space for anywhere near its proper price, diminishing their revenue and often causing negative feedback loops where more and more content space must be devoted to cheaper and cheaper advertising to meet revenue goals.

### SUMMARY

According to an exemplary embodiment, a business may collect customer data, such as data on customers that have signed up for user accounts, data on customers that have purchased products from the business, or data on customers who have browsed a website belonging to the business. This customer data may be on-boarded to a data management platform and used to better provide retargeted advertising to particular customers.

In an exemplary embodiment, a method of bridging offline and online retargeting of advertisements may be disclosed. Such a method may include receiving, on a data management platform including a processor and a memory, a customer data file associated with a customer, the customer data file including customer device data, as well as potentially other data, such as customer activity or customer communications. Such a method may further include performing at least one of: selecting one or more keywords in a customer communication provided in the customer data file, selecting one or more keywords summarizing a customer communication provided in the customer data file, selecting one or more keywords from a provided list of keywords, or selecting one or more keywords based on customer activity provided in the customer data file; associating, with a processor, the one or more keywords with a profile of the customer, submitting, with a processor, to an ad exchange, a bid request to provide advertising to the customer, the bid request including the customer device data; receiving, with a processor, customer browsing data indicating a URL of at least one website accessed by the customer; parsing, with a processor, visited website information including at least the URL of the at least one website, and identifying one or more keywords associated with the profile of the customer, flagging the profile of the customer; and providing a retargeted advertisement to the customer.

In another exemplary embodiment, a data management system for bridging offline and online retargeting of advertisements may be disclosed. The system may include a processor, a memory, and a network connection, the memory having stored on it computer code executable by the processor to cause the data management system to carry out the following steps: receiving, on the data management system, a customer data file associated with a customer, the customer data file including at least customer device data; performing at least one of: selecting one or more keywords in a customer communication provided in the customer data file, selecting one or more keywords summarizing a customer communication provided in the customer data file, selecting one or more keywords from a provided list of keywords, or selecting one or more keywords based on customer activity provided in the customer data file; associating, with the processor, the one or more keywords with a profile of the customer; submitting, with the processor, via the network connection, to an ad exchange, a bid request to provide advertising to the customer, the bid request including the customer device data; receiving, with the processor, customer browsing data indicating a URL of at least one website accessed by the customer, parsing, with the processor, visited website information including at least the URL of the at least one website, and identifying one or more keywords associated with the profile of the customer, flagging, in the memory, the profile of the customer; and transmitting, with the processor, a notification indicating that the customer has been flagged.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 depicts an exemplary embodiment of a method for bridging offline and online retargeting of advertising.

FIG. 2 depicts an exemplary embodiment of a method for bridging offline and online retargeting of advertising.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

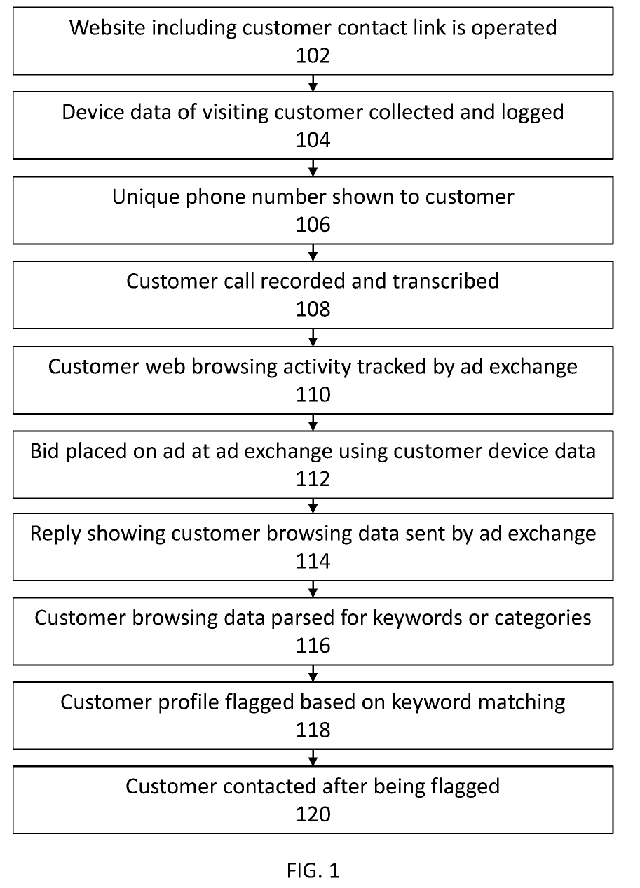

Referring now to FIG. 1, an exemplary embodiment of a method for advertising and marketing to customers may be described. According to an exemplary embodiment, a website, such as an advertising service website, may be operated 102 and may be accessible to customers and potential customers. Such a website may be associated with a pool of phone numbers, one or more of which may be shown to a customer (or other user of the website) when the customer navigates to the website. In some embodiments, a pool of phone numbers may be, for example, a pregenerated set of valid phone numbers, a space in which valid phone numbers may be dynamically generated, or another set of phone numbers, as desired.

In some embodiments, phone numbers may be temporarily associated with a customer, such as for a specific length of time; for example, according to an exemplary embodiment, a phone number may be deassigned from a customer and/or assigned to a different customer if the customer does not call the number within a day, or a week, of the customer seeing the advertisement and the phone number first being assigned. This may allow a more limited set of phone numbers to be used and cycled through. In other exemplary embodiments, phone numbers may be more fixedly associated with particular customers or sets of customers, as desired; this may allow the same phone number to be available to the same customer upon a return visit, if desired. Phone numbers may be, for example, toll free numbers (such as VoIP toll free numbers), may be local numbers, or may be some combination of the two or another set of numbers, as desired.

According to an exemplary embodiment, when a customer visits the website, information about the device on which the customer accessed the site may be logged 104. This may include, for example, information specifically used by the device for the purpose of identifying the device to advertisers (a “universal unique ID” or UUID, such as an Identifier for Advertising (IDFA) or Advertising ID (AAID) of the device). This information may also include the device IP address, or the device user agent (such as a web browser). This information may also include, for example, information associated with the device user agent, such as device user agent fingerprint information (such as the browser version number, device screen resolution, and device operating system), or other information associated with the device user agent such as browser cache information. Logged information may also include any other information that may be of relevance, as desired. Alternatively, or in addition to logging user data, tracking information may be stored on a user's device. For example, in an exemplary embodiment, a tracking cookie may be sent from the website and may be stored on the customer's device; in another exemplary embodiment, a similar mechanism, such as a web token system or an ETag system, may be used instead.

In an exemplary embodiment, when a customer navigates to the website, the phone number shown to the customer may be shown specifically to the customer and only to the customer 106, or may be, for example, specifically assigned to the customer for some temporary period as discussed above. If the customer calls the phone number shown to the customer, the phone number from which the customer places the call may be associated with the device ID that was last shown the phone number, or may be otherwise associated with the customer's device. This may have the effect of bridging the gap between the customer's offline activity and the customer's online activity, allowing some of the customer's offline activity (specifically their phone call) to be incorporated into profile information constructed from the customer's Web history.

In an exemplary embodiment, when a customer places a phone call to the phone number that has been shown to them, the call may be connected to staff associated with the advertising website or to staff that have some connection to the website. This may be, for example, sales staff, or to the staff of a business development center (BDC), or any other staff, as desired. Call information including the customer's phone number, for example the customer's caller ID information, may be logged.

In an exemplary embodiment, the substance of the customer's call may also be recorded and transcribed 108, for example using natural language processing or another speech-to-text technique, as may be desired. In some exemplary embodiments, keywords or key phrases may be captured from the customer's call; for example, textual keywords may be captured from the transcript of the customer's call. These keywords may be assigned to a stored profile of the customer, along with the phone number of the customer and other customer data. In some embodiments, these keywords may be, or may be used as the basis for the creation of, segments or categories into which the customer may be classified; this may, for example, allow for the profile of the customer to be anonymized, if desired.

The customer's web browsing activity may then be tracked across other websites that the customer visits 110. In an exemplary embodiment, tracking of the customer may be accomplished using, for example, a third-party ad exchange; in other exemplary embodiments, tracking of the customer may be performed by the operators of the advertising website that the customer initially visited, or by another party, as desired.

For example, according to an exemplary embodiment, one or more ad exchanges may store and track data that may be used to identify one or more devices of a particular customer. This may include, for example, a unique and pseudonymous device ID, device information such as device cookie information, or other customer information. As the customer navigates to different pages served by the one or more ad exchanges, the user information of the customer may be identified as requesting content from each of the pages, and may thus be tracked by the one or more ad exchanges.

In some exemplary embodiments, more than one device may be registered to a particular customer. For example, a customer may shop, look at advertising, or otherwise browse the Internet on a home desktop PC, a work laptop, and one or more mobile devices. In an exemplary embodiment, one or more ad exchanges may store and track data relating to two or more of the devices, or all of the devices, registered to the particular customer, for example by tracking the use of a user account controlled by the customer and shared between multiple devices. This may allow data on each of the tracked devices of the customer to be provided by the ad exchange based on the provision of information sufficient to identify one or more of the devices. For example, in an exemplary embodiment, a customer of a website may provide device data and a phone number to the operators of a website after the customer navigates to the website and places a call to a unique phone number provided to them 106. This customer information, sufficient to identify a mobile device of the customer on which they placed the call, may then be provided to an advertising exchange, which may in return provide information on that mobile device of the customer and some or all of the other devices known to be used by that customer.

In an exemplary embodiment, an ad exchange may be configured so that some or all of the user information of a particular customer may allow the particular customer to be targeted with a specific ad. For example, an ad exchange may retain customer information including user cookie information and a user-specific ID, and may solicit bids from other parties interested in showing ads to that customer, using a real-time bidding (RTB) process. If information is known about the customer—for example, if customer information has been collected using a tracking cookie on a machine of the customer—then bids may be specifically solicited from demand sources (demand-side platforms or “DSPs”) that serve purchasers of advertising space that are more relevant to the customer's known characteristics. If no information is known about the customer, then the advertising space may be auctioned based on, for example, context clues in the site itself, typically for a lower price than would be forthcoming if information was known about the customer to which the ad would be shown.

In some embodiments, customer tracking data, such as the websites visited by a particular customer, may be available or licensable from an advertising exchange. For example, in some cases, a company operating an advertising website may also be a company that owns an advertising exchange, and customer data information may be directly available. However, in other cases, customer tracking data may not be directly available. In an exemplary embodiment, in order to receive customer tracking data for a particular customer from an advertising exchange, a bid to show ads to the customer in question may be submitted to one or more ad exchanges. For example, according to an exemplary embodiment, a company associated with the advertising website may, using information obtained from the customer that is specific enough to allow the company to specifically target the customer on the ad exchange (a “targetable ID,” which may include information such as cookie information or a device ID), make a bid to show a display ad to the customer across one or more of the ad exchanges. This may be done by, for example, loading the targetable ID into a demand-side platform (DSP) or similar ad serving platform, and bidding using the DSP or similar platform. In an exemplary embodiment, the display ad may be shown to the customer on any Web-enabled device, such as a personal computer (such as a desktop or laptop computer), a tablet PC, or a mobile device, or on a combination of platforms, as desired; this may include a device other than the device used by the customer to initially browse the website or to place a call to the operator of the website.

In an embodiment, the process of submitting one or more bids to show a display ad to a particular customer may be used in order to obtain ad exchange tracking data related to the customer 112, such as to determine one or more sites that the customer has visited. For example, in an exemplary embodiment, a bid may be submitted from a DSP or similar platform to an ad exchange requesting that an ad be shown to a device having a particular UUID, and a reply may be sent from the ad exchange 114 containing information on the device having that UUID.

For example, according to an exemplary embodiment, a reply from the advertising exchange in response to a bid request may resemble the following:

{“ext”:{“ssl”:0},“tmax”:70,“at”:1,“user”:{“id”:“CAESEMPr9sW8LVDvbGFEra hSNvE”},“device”:{“ext”:{“browser_variant_id”:0,“browser_id”:5,“operatingsystem_va riant_id”:0,“operating_system id”:3,“device_id”:0,“device_type_id”:1,“timezone”:—300},“devicetype”:2,“language”:“en”,“geo”:{“ext”:{“normalized_city”:“walltownship”},“type”:2,“zip”:“07753”,“region”:“NJ”,“country”:“US”},“ip”:“74.105.90.0”,“ua”:“Mozilla/5 .0 (Macintosh; Intel Mac OS X 10_7_5) AppleWebKit/537.36 (KHTML, like Gecko) Chrome/39.0.2171.65 Safari/537.36,gzip(gfe)”},“site”:{“ext”:{“ias_segments”:[402144,402145,402146,402147, 513,510,509,504,503,512,511,1595,502,501,516,517,518,508,507,401,402,1500,506,505],“exchange_seller_id”: 1,“exchange_id”:4,“doubleclick_verticals”:[71,122,1512,1538],“a g_rank”:3.92240976418065),“page”:“http://www.example.com/maple-bbq-sauce/”,“domain”:“example.com”},“imp”:[{“ext”:{“h”:[250],“w”:[300],“flight_ids”:[3634],“allowed_types”:[1]},“banner”:{“pos”:3,“h”:250,“w”:300},“id”:“1-12280801740”}],“id”:“e156a5d2-7742-11e4-b79d-983c52001 aa5”}

This example reply may include some or all customer information known to the ad exchange about the customer corresponding to the specified UUID at the time that the bid was placed. For example, in the exemplary reply shown above, the geographical location of the customer has been derived based on certain device information of the customer, such as the customer's IP address, and corresponds to a location in Wall Township, NJ. The customer information provided in the reply may also include information about the website on which the ad was served; for example, the exemplary reply given above includes, as the URL where the display ad can be or was served to, “http://www.example.com/maple-bbq-sauce/,” and includes as the domain “example.com”. This indicates that the customer was browsing a page located on example.com and having to do, presumably, with maple barbecue sauce, based on the text of the URL.

According to an exemplary embodiment, one or more keywords may be harvested from the URL 116 by a data processing algorithm operated by a data management platform. For example, in the above URL, the words “maple,” “barbecue,” and “sauce” may be harvested; key phrases made up of more than one keyword, for example “barbecue sauce” and “maple barbecue sauce,” may also be harvested. In another URL, such as “http://example.com/vehicle/1HGCR3F04GA012489-2016-Honda-Accord-Sedan-EX-L-4dr-V6-Auto-EX-L-w-Navi-Honda-Sensing-Regular-Unleaded-V-6-3-5-L-212/,” other keywords, such as “Honda” or “Honda Accord,” may be harvested. In some embodiments, additional content, such as the content of the website to which the URL corresponds, may also be parsed for keywords, if desired.

In some exemplary embodiments, a website may also be associated with an entry in the Internet Advertising Bureau standard taxonomy, and this information (the “IAB category” of the website) may be provided in the reply. This information may then be used, in some or all cases, in lieu of a keyword or as a keyword. For example, if the IAB category of the website on which the ad was provided is sufficiently specific and sufficiently germane to a product or service to be marketed to the customer, the IAB category of one or more sites visited by the user may be tracked. For example, if a customer initially visits a website advertising trips to Greece and places a call to a travel agency based on the website, the relevant IAB category (in this case IAB category IAB20-16, which covers travel to Greece) may be used in place of a keyword, if desired. According to another exemplary embodiment, a website may have one or more other categorial classifications other than those used by the IAB, which may be used instead of or in addition to the IAB classifications, if desired.

According to an exemplary embodiment, a data management platform or other system running a parsing algorithm may parse URLs from one or more bid requests, or otherwise analyze information on the customer's browsing behavior obtained from the one or more bid requests, and may look for keywords to match against particular sources. In one exemplary embodiment, keywords may be matched against one or more keywords transcribed from a telephone call associated with a customer user profile, such as an initial phone call placed by a customer, which may be generated by, for example, natural language processing or other speech-to-text analysis of the telephone call. Other communications sent by the customer, such as an email or a text message, may also be parsed by a data management platform for one or more keywords. In some embodiments, the customer may be classified into one or more segments or categories, for example based on one or more keywords from the customer's communications; in these embodiments, keywords parsed from the bid requests may be matched against the segments or categories, as desired. In an embodiment, the segments or categories in which a customer is placed, or the keywords associated with the customer, may be used to refine bid requests to show ads to the customer, as desired.

According to another exemplary embodiment, one or more keywords may be manually added to the platform, for example by an advertising service. In an embodiment, these manually added keywords may be added as indicators of whether or not a person is in the market for a particular product.

To give an example of how this may function in practice, according to an exemplary embodiment, a customer may make an initial call to a car dealership after seeing an advertisement posted online. The customer's initial call, in which the customer indicates that they are looking for a fuel-efficient four-door sedan, may be recorded and parsed using natural language processing or another speech-to-text processing method. Additional keywords may then be added to the platform that were not present in the original telephone call or were not identified by the parsing algorithm as significant based on the additional phone call, which may be used as indicators that the customer is in market, or which may indicate, for example, the customer's preferences. For example, according to an exemplary embodiment, the makes and models of particular four-door sedans, such as the Honda Accord, may be added to a data management platform. The customer's activity may then be tracked.

According to an exemplary embodiment, parsing of a URL by the data management platform may be context-sensitive. In some cases, it may be that, by coincidence, a keyword or set of keywords may appear in a URL that has nothing to do with an advertised product. For example, the customer mentioned above, who had made an initial call inquiring about a four-door sedan, may later navigate to a news article about a diplomat, Ambassador Honda, negotiating a peace accord between warring countries (“http://www.example.com/news/ambassador-honda-negotiates-accord”). This URL would contain the keywords “Honda” and “Accord,” but would obviously not be useful as an indication that the customer is in the market for a Honda Accord. In an exemplary embodiment, a data management program may be configured to perform natural language processing to discern the subject of the article linked at the URL, or may deprioritize keywords when in connection with other keywords. For example, the keyword “accord” may be less likely to refer to the vehicle model when it appears in connection with the words “ambassador,” “negotiates,” or any other words implying that the word is being used to refer to an official agreement. As such, in an exemplary embodiment, the data management platform may be configured to ignore this URL in a customer's browsing activity.

According to an exemplary embodiment, a data management platform may identify the frequency with which particular keywords associated with a customer appear in the customer's browsing activity. The data management platform may then be configured to take some action based on the frequency with which these keywords appear.

According to an exemplary embodiment, the data management platform may be configured to flag a particular customer once a set of keywords have appeared more than once within a customer's browsing behavior 118. For example, when the customer has browsed a site with the keywords “Honda” and “Accord” in the URL, and then browsed another site having the same keywords in the URL, the customer's user profile may be flagged. In another exemplary embodiment, the data management platform may be configured to flag a particular customer once a set of keywords have appeared some specific number of times (for example, three times) within a customer's browsing behavior. In some exemplary embodiments, the thresholds that may be required for a customer's user profile to be flagged may differ according to the keywords used; for example, a more common keyword may be required to be used more often before the customer is flagged in order to reduce the impact of false positives, whereas a less common keyword may be required to be used less often before the customer is flagged.

In another exemplary embodiment, a customer may be flagged when they have browsed multiple sites having the same keywords within a particular length of time; for example, a customer may be flagged if they visit a page with “Honda Accord” in the URL, and then five minutes later visit a different page in a different domain with “Honda Accord” in the URL. A length of time may also be set in which the customer may be flagged; for example, a particular customer who has made a telephone call expressing potential interest in a purchase may be monitored for a week after making the telephone call, and if the customer is not flagged in that time, monitoring of them may cease. If the customer is flagged within that timespan, they may be contacted, for example when they become flagged or at the end of the timespan.

In some embodiments, this length of time may be dynamic; for example, the timespan over which a customer is to be monitored may be extended somewhat every time the customer navigates to a page having one or more keywords in the URL. For example, according to an exemplary embodiment in which a customer must access three separate URLs containing relevant keywords to be contacted, monitoring of the customer may cease if the customer does not access a first URL within three days, a second URL within six days (or, alternatively, within three days of the first URL), and a third URL within nine days. This may ensure that the customer has a sustained level of interest in an item to be purchased.

In some exemplary embodiments, the rules and algorithms that may be used to determine when to flag a customer as potentially being in-market for a particular product, or otherwise flagging a customer or the behavior of a customer, may be customized. In some embodiments, the rules for when to flag a customer may be customized based on the good or service to be sold. For example, in an exemplary embodiment, a more esoteric purchase that more rarely appears in keywords or is less likely to be searched for other than by an interested customer may have a lower threshold to trigger flagging, and a product that appears in keywords more often or which is more likely to be searched for by a customer who is not necessarily in the market to purchase the product yet may have a higher threshold to trigger flagging. Products that are more likely to be purchased by particular customers, such as sophisticated buyers that are more likely to want to perform a higher degree of research before purchasing the product (for example, expensive laboratory equipment), may also have higher or lower thresholds at which flagging may be triggered.

In other embodiments, the rules for when to flag a customer may be customized based on known attributes of the customer or based on previous communications of the customer, which may provide information about when the customer in question may be more likely to be in the market for a particular product than would otherwise be indicated or less likely to be in the market for a particular product than would otherwise be indicated. For example, in an exemplary embodiment, a flagging score or threshold of a customer may be customized based on the apparent intensity of the customer in the initial communication; a customer who is apparently eager to purchase a product and who appears to be a high-value bottom-of-the-funnel prospect may be assigned a lower score threshold and may be flagged based on comparatively little activity, and a customer who appears more reticent may be assigned a higher score threshold and flagged based on comparatively more activity.

In some embodiments, customers may also mention specific factors, in their initial communication or otherwise, that may increase their eagerness to purchase the product. These factors may also be taken into account when calculating the flagging score or the flagging score threshold of a customer. For example, if the customer mentions in an initial communication that they are having problems with their existing vehicle, a 1999 Honda Accord, and want to replace it with a newer automobile, the customer may be flagged based on having navigated to pages including the keywords “Honda Accord” and “2016 Honda Accord,” with greater emphasis being placed on the latter as compared to the former. (That is, the latter keyword may increment the flagging score of the customer by a greater amount than the former keyword, because it is more likely to indicate in-market browsing behavior of the customer.) However, if the customer navigated to pages including the keywords “Honda Accord auto repair,” this may cause the customer to be immediately flagged, based on the customer's initial communication indicating that they were having problems with their existing vehicle and the likelihood that the customer's browsing activity indicates that their vehicle is in need of repair.

When a customer has been flagged by the data management platform, in some embodiments, the customer may then be contacted 120; in some exemplary embodiments, the data management platform may trigger a call platform to place a call to the customer at the telephone number initially used by the customer. In an exemplary embodiment, the customer may be contacted immediately or at the next valid time. For example, in an exemplary embodiment, if a customer becomes flagged as being in the market for a particular product during a late-night internet browsing session, the customer may be contacted on the next business day, if desired. In other exemplary embodiments, the customer may be contacted at a specified time, such as a week from an initial telephone call of a customer, with the determination of whether to contact the customer being based on whether the customer has been flagged since making the initial telephone call. In some embodiments, a customer may be contacted by a time-insensitive communication method, such as via email or text message, before being called, to inform the customer that they will be called regarding their interest in a particular product or to request that the customer provide a time in which they wish to be called.

In other embodiments, the customer may be contacted by another communication method, rather than, or in addition to, being contacted by telephone call. For example, in an exemplary embodiment, the customer may be contacted by an SMS or MMS text message directed to the phone number of the customer, which may contain an offer to purchase a product (such as the subject of the customer's original telephone call) at a particular price, or may contain another advertisement or solicitation, as desired. This advertisement may be, for example, targeted to the customer or to one or more segments or categories into which the customer falls. In another embodiment, another communication, such as a mobile ad, may be pushed to the device of the customer. According to another exemplary embodiment, a user may first be contacted with a first communication, such as an email or text message, containing an advertisement, and later contacted with a second communication, such as a telephone call, if desired; for example, in an exemplary embodiment, a customer may first be contacted by an automatically-generated SMS message if they have met a minimum flagging score, but may then be contacted by telephone call if they have a particularly high flagging score.

In some embodiments, communications with the customer may be automatically or manually generated, or may be generated by a combination of the two methods. For example, in some exemplary embodiments, SMS or MMS messages, or other messages, provided to a customer may be generated and sent to the customer automatically. Other messages, such as telephone calls, may be placed manually, if desired. In some embodiments, this may allow dealer resources to be better prioritized to more promising or the most promising customers, while still ensuring that all customers who meet the minimum requirements for being flagged are contacted.

In an exemplary embodiment, a data management platform or other device may be configured to notify the staff of a business upon a customer being flagged. For example, in an exemplary embodiment, a sales or business development professional of the business may be emailed, called, texted, instant messaged, or otherwise notified that a particular customer has demonstrated in-market behavior, if desired. In some exemplary embodiments, calls or other communications with the customer may be accomplished manually, while in other exemplary embodiments calls to the customer may be placed automatically or other communications with the customer may be sent automatically.

Variations on the embodiments of the method described above may also be understood. To give one example of a variation, in one exemplary embodiment, the method may be applied to customer retention rather than customer solicitation, and the web browsing activity of customers may be tracked 110 for the purpose of determining when customers are considering moving their business to competitors, and/or which competitors they are planning on moving their business to. This may allow advertising to be targeted at those customers specifically addressing their potential concerns or otherwise dissuading them from purchasing from those competitors. In an exemplary embodiment, a score threshold may be generated for the customer based on an initial communication with the customer indicating, for example, that the customer is at risk of canceling a service or switching to a competitor to purchase product; in an embodiment, this may make use of retention-based segmentation. The browsing activity of the customer may then be tracked and the customer may be flagged, or a flagging score of the customer may be incremented, based on the browsing activity of the customer.

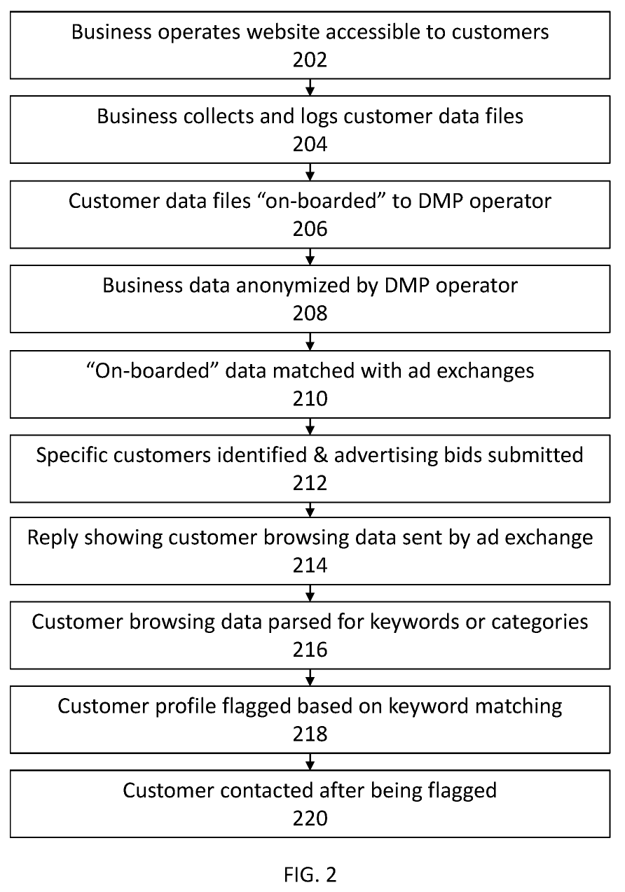

Turning now to exemplary FIG. 2, an alternative exemplary embodiment of a method for advertising and marketing to customers may be described. In an exemplary embodiment, a business operating an advertising website and the operator of a data management platform may be different entities, and customer data files may be provided from the business to the operator of the data management platform. This process of sending customer data files to a data management platform may be referred to as “on-boarding.”

In an alternative exemplary embodiment such as is shown in FIG. 2, a business or other entity separate from the operator of a data management platform may operate a website 202 that may collect some form of data from customers 204. In some embodiments, this data may include customer records, including for example the user profiles of customers that have created user accounts on the website operated by the business 202, or the digital IDs or other device information of customers who have browsed the site belonging to the business. In an exemplary embodiment, the business or other entity may also offer a link at which a customer may contact the business by telephone or by another communication method; in such an exemplary embodiment, the business or other entity may log data 204 including, for example, the content of a customer's telephone call or other communication, or the caller ID information of the customer. In another exemplary embodiment, the business may offer an online storefront system in which a customer may purchase one or more products from the business or an affiliate of the business, and collected data may include, for example, the item purchased by the customer.

Data collected by the business in this manner may be “on-boarded” to the operator of a data management platform 206, for example as the data is collected. The operator of the data management platform may then, if necessary, anonymize the business data 208. For example, the data management platform may be configured to remove customer names, addresses, and other personal information that may be present in customer shipping information submitted from a business online storefront page, or may be configured to remove any other personal information from a customer data file, as desired.

In an exemplary embodiment, the data management platform may then proceed according to the same or similar steps to those depicted in FIG. 1. In some embodiments, the “on-boarded” customer data in the data management platform may be connected to a demand-side platform, which may then be used to connect to one or more ad exchanges and match the customer records of the business to devices and digital IDs across the connected ad exchanges 210. Matching 210 may take place using, for example, a cookie sync or a device ID sync, or another method of matching, as may be desired. In an exemplary embodiment, this may be used in order to identify specific customers, establishing a one-to-one match between visitors who interacted with the website (such as customers who purchased something from an online storefront) and entries in the business's data management system (DMS), customer relationship management software (CRM), or other database.

Advertising bids may then be submitted to one or more of the ad exchanges for the specific customers that have been successfully identified 212. A reply or replies may then be received from the one or more ad exchanges 214, the reply or replies containing customer data such as browsing activity, such as the URL that the customer was browsing when the bid request was submitted. Other information, such as the IP address or latitude and longitude of the PC, tablet, or mobile device being used by the customer, or the device ID, cookie ID, browser, and/or operating system of the device being used by the customer, may also be received in a reply, if desired. The browsing activity of the customer may then be parsed for keywords 216; for example, in some exemplary embodiments, the URLs of the sites visited by the customer may be parsed for keywords, the content of the sites visited by the customer may be parsed for keywords, or one or more categories used to classify the content of the site may be used as or may be used to generate keywords. The customer's profile may then be flagged based on the presence or absence of particular keywords in the customer's browsing activity 218, and if the customer is flagged, may be contacted 220.

In an exemplary embodiment, keywords may be selected based on the customer's activity on or after interacting with a website being operated by a business 202. For example, if a customer record indicates that a customer has purchased one or more items from a business online storefront, keywords may be selected from a list of related items which may be similar to or related to the purchased items. Keywords may also be based on other customer behavior, for example a communication between the customer and the business, or a pattern of activity on the part of the customer, for example, in one exemplary embodiment, the URL or the content of one page on which an ad was bid to be served may be matched against the URL or the content of another page on which an ad was bid to be served. Alternatively, keywords may be manually specified by the business and/or by the DMP operator, as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method of bridging offline and online retargeting of advertisements, the method comprising:
receiving, on a data management platform comprising a processor and a memory, a customer data file associated with a customer, the customer data file comprising customer device data;
performing at least one of: selecting one or more keywords in a customer communication provided in the customer data file, selecting one or more keywords summarizing a customer communication provided in the customer data file, selecting one or more keywords from a provided list of keywords, or selecting one or more keywords based on customer activity provided in the customer data file;
associating, with a processor, the one or more keywords with a profile of the customer;
submitting, with a processor, to an ad exchange, a bid request to provide advertising to the customer, the bid request including the customer device data;
receiving, with a processor, customer browsing data indicating a URL of at least one website accessed by the customer;
parsing, with a processor, visited website information including at least the URL of the at least one website, and identifying one or more keywords associated with the profile of the customer in at least one of a hostname and a pathname of the URL of the at least one website;
flagging the profile of the customer; and
providing a retargeted advertisement to the customer.

2. The method of claim 1, wherein the customer data file is provided in an anonymized form.

3. The method of claim 1, further comprising:
with a processor, stripping identifying information from the customer data file to yield anonymized customer data.

4. The method of claim 1, wherein the customer data file comprises at least one customer communication, the customer communication comprising at least one of text or a recording of a telephone call of a customer.

5. The method of claim 4, wherein the customer communication comprises a recording of a telephone call of a customer, and wherein the method further comprises:
transcribing, with a processor configured to perform speech-to-text processing, the content of the telephone call of the customer, and generating a transcript of the content.

6. The method of claim 5, wherein the step of transcribing the content of the telephone call of the customer further comprises performing, with a processor, natural language processing on the content of the telephone call of the customer.

7. The method of claim 1, wherein customer device data comprises at least one of: a device-specific identifier or cookie data.

8. The method of claim 1, wherein the step of providing a retargeted advertisement to the customer constitutes at least one of: contacting the customer by telephone at the telephone number of the customer, sending a text message to the customer at the telephone number of the customer, or sending a mobile ad to the device of the customer.

9. The method of claim 1, further comprising sending an alert to a third party indicating that the profile of the customer has been flagged.

10. The method of claim 1, wherein the step of parsing visited website information including at least the URL of the at least one website, and identifying one or more keywords associated with the profile of the customer, further comprises:
accessing, with a processor, website content hosted at the URL of the at least one website;
parsing, with a processor, the website content;
identifying, with a processor, a keyword associated with the profile of the customer located in at least one of: the URL of the at least one website, the content of the website, and a categorial classification of the website; and
flagging the profile of the customer based on the presence of the identified keyword.

11. The method of claim 1, wherein the step of parsing visited website information including at least the URL of the at least one website, and identifying one or more keywords associated with the profile of the customer, further comprises:
performing, with a processor, natural language processing on the visited website information; and
distinguishing, with a processor configured to use natural language processing, between keywords associated with the profile of the customer and identically-spelled and similarly-spelled keywords not associated with the profile of the customer; and
flagging the profile of the customer based on the presence of a keyword associated with the profile of the customer.

12. The method of claim 1, further comprising flagging the profile of the customer based on the presence of a plurality of keywords in the visited website information and an association of the plurality of keywords.

13. The method of claim 1, wherein flagging a customer profile associated with a customer comprises tracking a flagging score of the customer profile and triggering flagging of the customer profile when the flagging score is over a certain threshold; and
wherein the detection of a keyword increments the flagging score.

14. The method of claim 13, wherein a plurality of keywords are associated with the profile of a customer, and wherein detection of a first keyword in the plurality of keywords increments the flagging score by a different amount than the detection of a second keyword in the plurality of keywords.

15. The method of claim 13, wherein detection of a second keyword after a first keyword increments the flagging score by a variable amount based on the difference in time between the user's navigation to a website having website information including the first keyword, and the user's navigation to a website having website information including the second keyword.

16. The method of claim 13, wherein the flagging score is varied based on a known attribute of the customer that is stored in the customer profile.

17. The method of claim 13, wherein the flagging score is automatically decreased, by a processor, after a period of time has passed.

18. A data management system for bridging offline and online retargeting of advertisements, the system comprising a processor, a memory, and a network connection, the memory comprising computer code executable by the processor to cause the data management system to carry out the following steps:
receiving, on the data management system, a customer data file associated with a customer, the customer data file comprising customer device data;
performing at least one of: selecting one or more keywords in a customer communication provided in the customer data file, selecting one or more keywords summarizing a customer communication provided in the customer data file, selecting one or more keywords from a provided list of keywords, or selecting one or more keywords based on customer activity provided in the customer data file;
associating, with the processor, the one or more keywords with a profile of the customer;
submitting, with the processor, via the network connection, to an ad exchange, a bid request to provide advertising to the customer, the bid request including the customer device data,
receiving, with the processor, customer browsing data indicating a URL of at least one website accessed by the customer;
parsing, with the processor, visited website information including at least the URL of the at least one website, and identifying one or more keywords associated with the profile of the customer in at least one of a hostname and a pathname of the URL of the at least one website;
flagging, in the memory, the profile of the customer; and
transmitting, with the processor, a notification indicating that the customer has been flagged.

19. The data management system of claim 18, wherein the data management system is further configured to strip identifying information from the customer data file to yield anonymized customer data.

20. The data management system of claim 18, wherein the data management system is further configured to perform at least one of: triggering a call platform to connect to a telephone number of the customer, triggering a text message to be sent to the telephone number of the customer, or triggering a mobile ad to be sent to the device of the customer.
